(19) United States
(12) Patent Application Publication
(10) Pub. No.: US 2023/0404313 A1
(43) Pub. Date: Dec. 21, 2023

(54) HEAT-COLLECTING AND ENERGY-EFFICIENT POT FOR GAS STOVE

(71) Applicants: Xiao Chen, Ningbo (CN); Kecheng Jiang, Shengzhou (CN)

(72) Inventors: Xiao Chen, Ningbo (CN); Kecheng Jiang, Shengzhou (CN)

(21) Appl. No.: 17/840,657

(22) Filed: Jun. 15, 2022

(51) Int. Cl. A47J 27/02

(52) U.S. Cl. CPC A47J 27/02

(57) ABSTRACT

A heat-collecting and energy-efficient pot for gas stove is formed of a main body, an outer casing outside said main body, a top edge made integrally with said main body, a base of said main body smaller than said top edge, a loop molded inwards at the bottom of said outer casing, said loop being in contact with said base, a plurality of through-holes evenly provided on said loop for the flame to pass through, two symmetrical handles on said outer casing, a plurality of smoke exhaust holes on the wall between said two handles at the upper end of said outer casing, and a heat-collecting chamber between said outer casing and said main body; when the heat-collecting and energy-efficient pot for gas stove is used, the extended flame enters the heat-collecting chamber via the through-holes and exchanges heat with the side wall of the main body to facilitate energy collection and the smoke is discharged from the smoke exhaust holes. It is verified that the use of this energy-efficient pot may significantly improve the thermal efficiency.

### TECHNICAL FIELD

This disclosure relates to a heat-collecting and energy-efficient pot for gas stove.

### BACKGROUND ART

Gas stoves refer to kitchen appliances that are directly heated by gaseous fuels such as coal gas and natural gas. Equipped with pipeline natural gas, a gas stove has become a must-have kitchen utensil for every home. When an existing pot is used on a gas stove, part of the flame may heat up the outside of the pot while the flame is touching the pot base. As the extended flame is completely exposed to the air, the heat quickly dissipates in the air, and the side wall of the pot absorbs only a small amount of it, resulting in substantial energy losses, which is contrary to the concept of energy conservation and environmental protection. Furthermore, with rising gas prices, reducing unnecessary energy consumption also helps to cut daily costs.

### SUMMARY OF THE INVENTION

The objective of the present invention is to overcome the above mentioned deficiencies in the prior art and provide a heat-collecting and energy-efficient pot for gas stove.

In order to achieve the above objective, the present invention provides a heat-collecting and energy-efficient pot for gas stove, comprising a main body, an outer casing outside said main body, a top edge made integrally with said main body, a base of said main body smaller than said top edge, a loop molded inwards at the bottom of said outer casing, said loop being in contact with said base, a plurality of through-holes evenly provided on said loop for the flame to pass through, two symmetrical handles on said outer casing, a plurality of smoke exhaust holes on the wall between said two handles at the upper end of said outer casing, and a heat-collecting chamber between said outer casing and said main body;

When the heat-collecting and energy-efficient pot for gas stove is used, the extended flame enters the heat-collecting chamber via the through-holes and exchanges heat with the side wall of the main body to facilitate energy collection and the smoke is discharged from the smoke exhaust holes. It is verified that the use of this energy-efficient pot may significantly improve the thermal efficiency.

As a further improvement of the scheme, said outer casing and said handles are supported by refractory ceramics;

In the above technical scheme, refractory ceramics provide effective thermal resistance to avoid burning hands, and play a role of heat collection through reduced heat loss into the air.

As a further improvement of the scheme, said main body is fixedly connected with said outer casing;

In the above technical scheme, the fixed connection brings an integral and solid structure, and convenient use.

As a further improvement of the scheme, said main body is placed on the upper edge of said outer casing; the inner wall of said outer casing has a plurality of positioning pins molded inwards; and said positioning pins are fitted with the outer wall of said main body;

In the above technical scheme, the split design enables easy cleaning; the main body or the outer casing can be replaced separately if damaged, which saves resources; and the positioning pins may prevent possible dislocation between the main body and the outer casing.

As a further improvement of the scheme, said base protrudes upwards to form a frustum of a cone;

In the above technical scheme, the design of the frustum-shaped base increases the contact area between the base and the flame, and thereby facilitates heat collection.

Compared with the prior art, the present invention has the following beneficial effects: When the heat-collecting and energy-efficient pot for gas stove is used, the extended flame enters the heat-collecting chamber via the through-holes and exchanges heat with the side wall of the main body to facilitate energy collection and the smoke is discharged from the smoke exhaust holes. It is verified that the use of this energy-efficient pot may significantly improve the thermal efficiency.

### BRIEF DESCRIPTION OF THE FIGURES

FIG. 1 shows a front view of a heat-collecting and energy-efficient pot for gas stove of the present invention;

FIG. 2 shows a bottom view of a heat-collecting and energy-efficient pot for gas stove of the present invention;

FIG. 3 shows a perspective view of a heat-collecting and energy-efficient pot for gas stove of the present invention;

FIG. 4 shows a cross-sectional view of a heat-collecting and energy-efficient pot for gas stove of the present invention.

In the accompanying drawings: 1. Main Body; 11. Top Edge; 12. Base; 2. Outer Casing; 21. Loop; 211. Through-hole; 22. Smoke Exhaust Hole; 3. Handle; 4. Heat-Collecting Chamber.

### BEST MODE FOR CARRYING OUT THE INVENTION

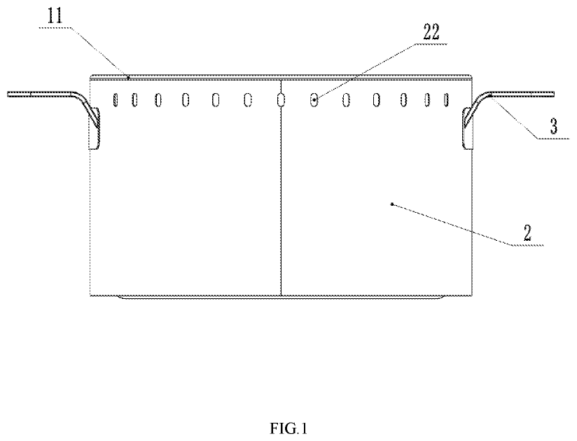

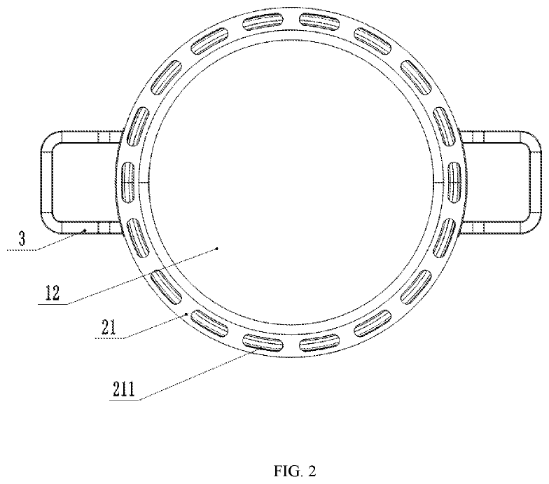

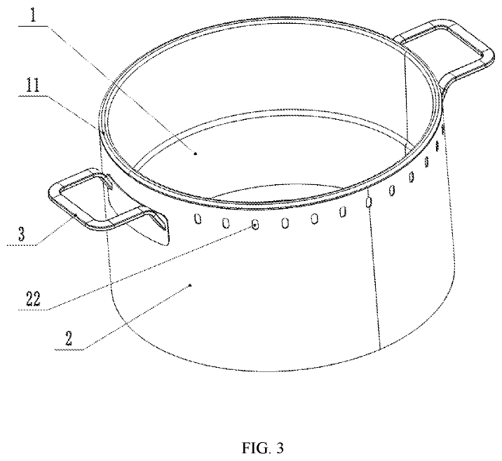

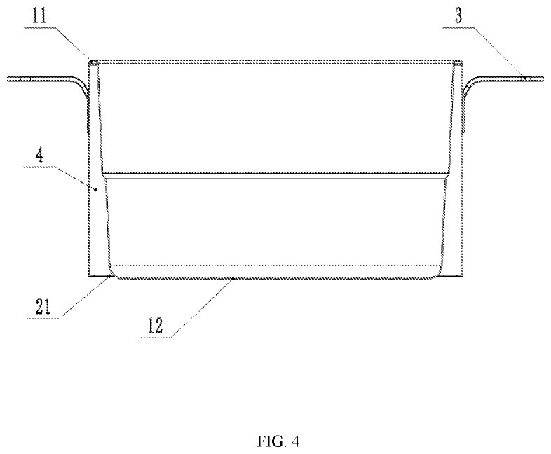

FIGS. 1 through 4 illustrate the preferred embodiment of the present invention, a heat-collecting and energy-efficient pot for gas stove, comprising a main body 1, an outer casing 2 outside said main body 1, a top edge 11 made integrally with said main body 1, a base 12 of said main body 1 smaller than said top edge 11, a loop 21 molded inwards at the bottom of said outer casing 2, said loop 21 being in contact with said base 12, a plurality of through-holes 211 evenly provided on said loop 21 for the flame to pass through, two symmetrical handles 3 on said outer casing 2, a plurality of smoke exhaust holes 22 on the wall between said two handles 3 at the upper end of said outer casing 2, and a heat-collecting chamber 4 between said outer casing 2 and said main body 1; wherein, said outer casing 2 and said handles 3 are supported by refractory ceramics which provide effective thermal resistance to avoid burning hands, and play a role of heat collection through reduced heat loss into the air; said main body 1 is fixedly connected with said outer casing 2, and the fixed connection brings an integral and solid structure, and convenient use; or, said main body 1 is placed on the upper edge of said outer casing 2; the inner wall of said outer casing 2 has a plurality of positioning pins molded inwards; and said positioning pins are fitted with the outer wall of said main body 1; the split design enables easy cleaning; the main body or the outer casing can be replaced separately if damaged, which saves resources; and the positioning pins may prevent possible dislocation between the main body and the outer casing; said base 12 protrudes upwards to form a frustum of a cone, and the design of the frustum-shaped base increases the contact area between the base and the flame, and thereby facilitates heat collection.

When the heat-collecting and energy-efficient pot for gas stove is used, the extended flame enters the heat-collecting chamber via the through-holes and exchanges heat with the side wall of the main body to facilitate energy collection and the smoke is discharged from the smoke exhaust holes. It is verified that the use of this energy-efficient pot may significantly improve the thermal efficiency.

The accompanying drawings are included to provide a further understanding of the present invention;

When in use, the extended flame enters the heat-collecting chamber via the through-holes and exchanges heat with the side wall of the main body to facilitate energy collection and the smoke is discharged from the smoke exhaust holes.

The foregoing description is merely a preferred embodiment of the present application, and is not intended to limit the present application. For those skilled in the art, the present invention may have various changes and variations. Thus, it is intended that the present invention cover all such alternatives, modifications, and equivalents made within the spirit and principle of the present disclosure.

1. A heat-collecting and energy-efficient pot for gas stove, characterized in that it is formed of a main body, an outer casing outside said main body, a top edge made integrally with said main body, a base of said main body smaller than said top edge, a loop molded inwards at the bottom of said outer casing, said loop being in contact with said base, a plurality of through-holes evenly provided on said loop for the flame to pass through, two symmetrical handles on said outer casing, a plurality of smoke exhaust holes on the wall between said two handles at the upper end of said outer casing, and a heat-collecting chamber between said outer casing and said main body.

2. The heat-collecting and energy-efficient pot for gas stove of claim 1, wherein said outer casing and said handles are supported by refractory ceramics.

3. The heat-collecting and energy-efficient pot for gas stove of claim 1, wherein said main body is fixedly connected with said outer casing.

4. The heat-collecting and energy-efficient pot for gas stove of claim 1, wherein said main body is placed on the upper edge of said outer casing; the inner wall of said outer casing has a plurality of positioning pins molded inwards; and said positioning pins are fitted with the outer wall of said main body.

5. The heat-collecting and energy-efficient pot for gas stove of claim 1, wherein said base protrudes upwards to form a frustum of a cone.
